(19) United States
(12) Patent Application Publication
(10) Pub. No.: US 2013/0284218 A1
(43) Pub. Date: Oct. 31, 2013

(54) CLEANING DEVICE FOR LAWN MOWERS

(71) Applicant: NEUCO GMBH, Neudorf/Wildon (AT)

(72) Inventor: Hannes Neuhold, Mellach (AT)

(73) Assignee: Neuco GmbH, Neudorf/Wildon (AT)

(21) Appl. No.: 13/871,997

(22) Filed: Apr. 26, 2013

(30) Foreign Application Priority Data
Apr. 27, 2012 (AT) GM 50034/2012
Jan. 30, 2013 (EP) 13153186.5

(51) Int. Cl. A01D 34/00

(52) U.S. Cl. CPC A01D 34/003
USPC 134/199; 134/198

(57) ABSTRACT

A device for cleaning a lawn mower comprises a cleaning tub for positioning the lawn mower. Outflow openings for a cleaning agent are arranged at an upper tub side of the cleaning tub. The outflow openings are connected with a cleaning agent chamber integrated in the cleaning tub at a lower tub side.

### BACKGROUND OF THE INVENTION

1. Field of the Invention

The invention relates to a device for cleaning a lawn mower, comprising a cleaning tub for positioning the lawn mower, wherein outflow openings for a cleaning agent are arranged at an upper tub side.

2. Description of Prior Art and Related Information

It has proven positive to clean lawn mowers directly after every single mowing process and remove any adhering grass cuttings. The term lawn mower includes in principle any known state-of-the-art lawn mowers, in particular electro- or gas motor driven lawn mowers having rollers, rolls or air cushions as well as known lawn mower tractors, which the driver may sit on while mowing.

After use the lawn mower is in the most cases tilted to the side for cleaning, and the contaminations and deposits at the lower side thereof are washed off with a water hose. By removing grass cuttings in particular in the knife chamber of the lawn mower there is prevented that the cutting faces of the knife tools corrode and become blunt during the idle periods of the lawn mower, this is in-between mowing processes. Cleaning on a regular basis will not only increase service life of the lawn mower but rather also prevent worsening of the cutting effects when mowing.

By regular cleaning directly after the respective mowing process there is prevented that the grass cuttings adhering to the lawn mower will shrivel up and become so hard that removal is only possible in a mechanical way with mostly enormous efforts. Such a mechanical cleaning of the knife chamber, however, is very dangerous and may lead to severe injuries in particular with motor-driven lawn mowers, which are not sufficiently protected against unintentional start-up. As tools for the mechanical cleaning there are most frequently used scrapers, knives, blades or wire brushes. These tools, however, have the disadvantage that the housing of the lawn mower will be scratched or damaged, respectively, therewith.

The currently used cleaning methods are disadvantageous insofar as in each case the lawn mower has to be tilted to the side with huge effort and secured in this tilted position in the case of wet cleaning by means of washing off with a water hose as well as in the case of mechanical dry cleaning. In wet cleaning it is further disadvantageous that the grass cuttings will be distributed within a larger radius around the site of cleaning due to the line pressure of the water hose and that the cleaning person will be contaminated by moist grass cuttings and water splashing around. For this reason, it is nearly impossible, in particular for older and more fragile persons, to perform regular cleanings of the lawn mower using conventional cleaning methods.

From prior art there is, for example, known a cleaning device for lawn mowers from the document U.S. Pat. No. 3,856,028. Thereby, a lawn mower to be cleaned is arranged on a platform made of wood, plastics or metal, which has a circular opening in the region of the mowing knife. At the edge of this opening, a hose is circumferentially attached in circular arrangement, which has several hose openings at the upper side thereof. The annular hose is therefore connected with a water line, through which water flows through the hose openings upwards to the lower side of the dirty lawn mower. In this embodiment it is of a disadvantage that the hose openings are arranged only along the annular hose, which is why a uniform and thorough cleaning of the entire knife region of a lawn mower using this cleaning device is not possible. Also if the lawn mower remains on the cleaning device for a long period of time, firmly adhering contaminations in the area of the mower knife may be cleaned only insufficiently. An additional manual or mechanical, respectively, cleaning thus is still required in order to thoroughly clean a lawn mower after its use.

### BRIEF SUMMARY OF THE INVENTION

The invention aims to overcome the drawbacks of prior art and therefore provide a cleaning device for lawn mowers, by means of which a regular as well as quick cleaning of the lawn mower is carried out especially conveniently, without any effort as well as without any contamination of the cleaning person.

These tasks are solved by a cleaning device according to the preamble of claim 1 with the features of the characterizing part of claim 1. The depending claims relate to further especially advantageous embodiment variants of the invention.

In a device according to the invention for cleaning a lawn mower, comprising a cleaning tub for positioning the lawn mower, wherein outflow openings for a cleaning agent are arranged at the upper tub side, the outflow openings are connected with a cleaning agent chamber integrated in the cleaning tub at a lower tub side. Such a cleaning device offers numerous advantages: upon use of the lawn mower, it is positioned in the cleaning tub of the device, at the upper tub side of which there are provided outflow openings. The outflow openings are positioned at the upper tub side preferably in such a way that these correspond essentially to a contour of the lawn mower, in particular a contour of the knife chamber of the lawn mower to be cleaned. A cleaning agent, for example water, may be sprayed trough the outflow openings, from the lower tub side upwards to the lower side of the lawn mower. Grass cuttings adhering to the lower side of the lawn mower are loosened up in this way and rinsed off and reaches the cleaning tub. If the cleaning process has been completed, the wet grass cuttings may be simply removed from the cleaning tub and disposed of. The outflow openings are thereby connected with a cleaning agent chamber integrated in the cleaning tub, which is arranged at a lower tub side. A cleaning agent, which is introduced in the cleaning agent chamber under pressure, thus moves via the outflow openings in a distributed way to the upper tub side, or it exits the cleaning agent chamber through the outflow openings upwards, respectively. Through the cleaning agent chamber, which is filled with a cleaning agent and acts like a cleaning agent puffer, an especially uniform water jet of the cleaning agent exiting upwards is guaranteed comparable with a shower head.

In a cleaning device according to the invention the cleaning agent chamber is usefully connected with a cleaning agent terminal As a cleaning agent terminal there is, for example, provided a hose terminal or adapter, respectively, for a garden water hose. In this way, the cleaning device may be independently operating for a longer period of time with a water hose connected. Thereby, water as a cleaning agent enters the cleaning agent chamber and from there upwards through the outflow openings to the lower side of the lawn mower to be cleaned, which is situated in the cleaning tub. Depending on the adjusted pressure of the cleaning agent or depending on the cleaning duration, respectively, even persistent deposits at the lower side of the lawn mower may be cleaned conveniently and without any effort. Instead of clear water as a cleaning agent there may also be used a cleaning agent containing an additional detergent.

In a cleaning device according to the invention the cleaning agent terminal protrudes laterally at the cleaning tub. For this reason, it is especially simple to couple the cleaning device with the garden water hose, or to decouple it therefrom, respectively.

In a first preferred embodiment variant of the invention, the outflow openings are arranged in a cleaning device at the upper tub side essentially in lines, preferably in a circular form. In this embodiment the outflow openings have, e.g., the outline contour of the knife chamber of the lawn mower.

In a further preferred embodiment variant of the invention the outflow openings are arranged in a cleaning device in concentric circles at the upper tub side. In this embodiment the outflow openings have, e.g., the contour of the knife chamber of the lawn mower positioned above, reaching into the centre of the knife chamber approximately into the region of the knife axis of the lawn mower.

In a further preferred embodiment variant of the invention the outflow openings are arranged in a cleaning device at least at an area section of the upper tub side. In this embodiment the outflow openings are distributed, for example, uniformly across the area of the contour of the knife chamber of the lawn mower positioned above.

In a cleaning device according to the invention the outflow openings are advantageously provided each with an outflow nozzle, preferably each with an internal outflow nozzle. In this embodiment each outflow opening has an outflow nozzle at the upper tub side. Such outflow nozzles are essentially comparable with the nozzles in a shower head and have the advantage that the exit velocity of the cleaning agent or the water, respectively, is increased in the outflow nozzles. In this way, there is achieved an especially thorough cleaning of a lawn mower with comparably low consumption of cleaning agent. The outflow nozzles are arranged preferably within the cleaning tub or within the outflow openings, respectively, which is why damage to or contamination of the outflow nozzles is prevented.

In a cleaning device according to the invention there is usefully provided at the upper tub side of the cleaning tub at least at a lateral edge, preferably at least at two opposing lateral edges, in each case a restricting border. The restricting borders will prevent that the lawn mower laterally slides off the cleaning device. In particular in the case of heavy lawn mower tractors this is of importance in order to not endanger persons in the near proximity by a lawn mower sliding off the device. In this embodiment there is further reliably prevented by way of restricting borders during the cleaning process contamination due to water splashing out laterally from underneath the lawn mower or due to grass cuttings exiting laterally. By way of the restricting borders, water and grass cuttings will be collected in the cleaning tub during the cleaning process, or these may exit the cleaning tub only at the sides having no restricting borders. Within the scope of the invention there are conceivable different embodiment forms: for example, there may be provided in a rectangular device restricting borders at both longitudinal sides, at both longitudinal sides as well as at a narrow side or at all lateral edges of the device.

In a cleaning device according to the invention at least one lateral edge of the cleaning tub is provided with a chamfer. A chamfer at least at a lateral edge facilitates positioning the lawn mower on the device or in the cleaning tub, respectively, for cleaning.

In a further embodiment according to the invention of the cleaning device, the upper tub side and lower tub side are section-wise adjoining each other. These sections, at which the upper tub side and the lower tub side adjoin each other, are intended for reinforcing the cleaning device. By these crimps or stiffeners, respectively, which may be arranged like ridges, it is made possible to position even high loads on a cleaning device according to the invention, as this is the case, e.g., with lawn mowers or mowing tractors, respectively with a seat.

In a further advantageous embodiment variant of the invention the upper tub side and the lower tub side are connected with each in a cleaning device in the sections, in which they are adjoining each other. These crimped sections, at which the upper tub side and the lower tub side are connected with each other, are intended as especially robust reinforcement ridges. Deforming or winding up this cleaning device is thus reliably prevented by these reinforcement ridges.

In a development of the invention there is provided in a cleaning device at the upper tub side at least one drain through. Such a drain through is intended so that during the cleaning process residues of the mown grass may be especially easily washed off the upper tub side.

In a cleaning device according to the invention a tub height of the cleaning tub especially advantageously amounts for at most 50 mm, preferably at most 15 mm. In this way, the flat cleaning device may be stored, when it is not used, especially space-savingly and easily.

A cleaning device according to the invention is usefully made of one or several of the following materials: plastics, in particular polyethylene (PE) plastics, fibre-reinforced plastics, in particular glass fibre-reinforced polyester resin, metal, composite materials. Depending on the size and the weight of the lawn mower to be cleaned it is recommended to use a cleaning device made of an especially robust material such as, e.g., metal or glass fibre reinforced polyester resin, in order to clean heavy lawn mower tractors. The cleaning device is advantageously provided with planar and smooth surfaces, which are especially easy to clean.

### BRIEF DESCRIPTION OF THE DRAWINGS

Further details, features and advantages of the invention become obvious from the following description of an exemplary embodiment that is schematically illustrated in the drawings, wherein:

FIG. 1 shows a device according to the invention in a top view;

FIG. 2 shows the device depicted in FIG. 1 in a side view;

FIG. 3 shows the device in a sectional side view according to the sectional plane A-A drawn in FIG. 1;

FIG. 4 shows a further embodiment of a device according to the invention in a side view;

FIG. 5 shows the lower tub side of the device shown in FIG. 5 in a view from below;

FIG. 6 shows the cleaning tub according to the sectional plane B-B drawn in FIG. 5 in a sectional side view;

FIG. 7 shows the detail C marked in FIG. 6 in an enlarged sectional view;

FIG. 8 shows a further embodiment variant of a device according to the invention in a top view;

FIG. 9 shows the device according to the sectional plane C-C drawn in FIG. 8 in a sectional side view.

### DETAILED DESCRIPTION OF THE PREFERRED EMBODIMENTS

FIG. 1 illustrates a cleaning device 1 having an essentially rectangular cleaning tub 2. At the two opposing longitudinal sides of the cleaning tub 2 there are provided lateral restricting borders 3 as splash guards. A lawn mower to be cleaned is herein positioned between the restricting borders 3 into the cleaning tub 2, wherein the lower side of the lawn mower not illustrated is spaced apart from the upper tub side 4 essentially uniformly. At a lower tub side 5, this is at the side of the cleaning tub 2 facing away from the lawn mower, there is positioned a cleaning agent chamber 6, which is connected with outflow openings 7 towards the upper tub side 4. The cleaning agent chamber 6 is provided with a lateral cleaning agent terminal 8. For example, a garden water hose may be releasably coupled with the cleaning agent terminal 8 by way of an adapter known per se. The outflow openings 7 are herein arranged approximately in a circular way at the upper tub side 4, corresponding essentially to the outline contour of the knife chamber of a lawn mower.

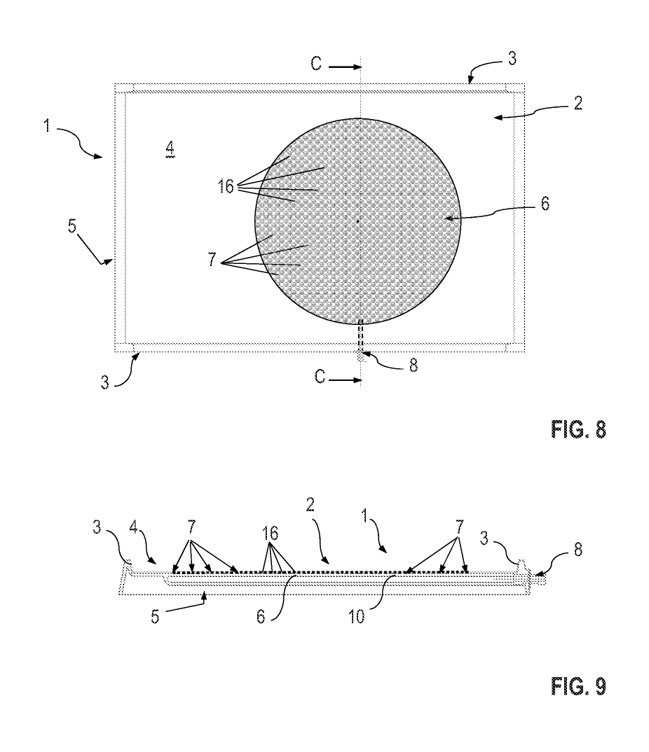

There is also conceivable within the scope of the invention that outflow openings 7 are distributed extensively across an area section of the upper tub side 4. This is depicted, for example, in FIG. 8. It is further conceivable and comprised by the scope of the invention that outflow openings 7 are distributed in several linear sections, for example alongside of concentric circular lines, at the upper tub side 4. These embodiments are not explicitly illustrated in the figures.

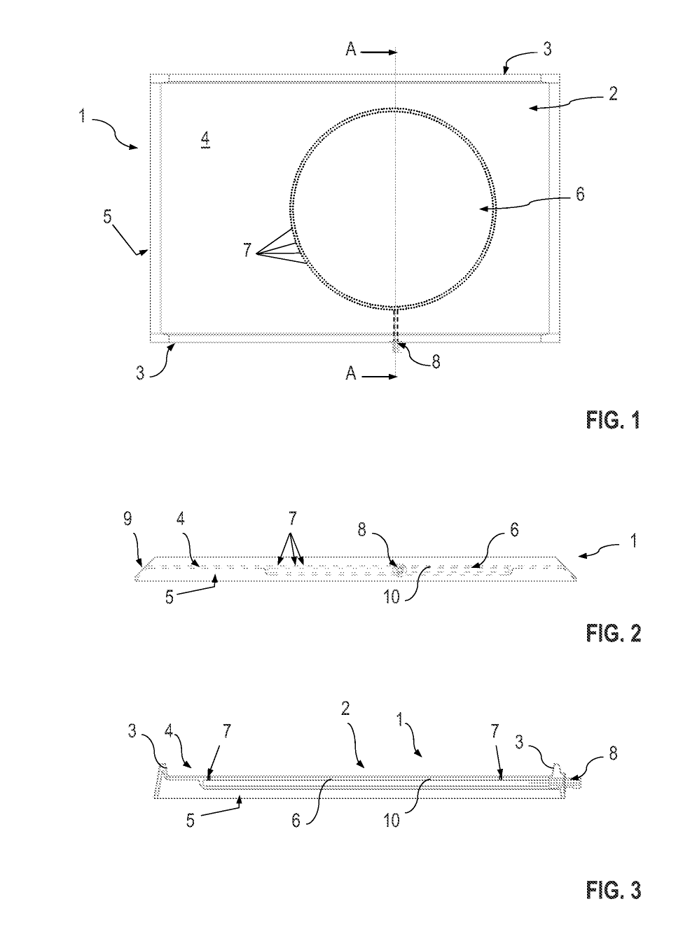

FIG. 2 shows the device 1 illustrated in FIG. 1 in a side view. Laterally, at the narrow sides of the rectangular cleaning tub 2, there are visible in each case chamfers 9. These chamfers 9 are intended to make it possible to push the lawn mower to be cleaned laterally onto the cleaning tub 2 in a convenient way and without any further efforts. Upon cleaning, the lawn mower may be rolled off device 1 at the opposite narrow side simply across the chamfer 9. The restricting borders 3 provided along the longitudinal sides prevent in a reliable way that grass cuttings exit laterally from underneath the lawn mower during cleaning. The restricting borders 3 further prevent in a reliable way that the lawn mower slides off laterally during cleaning. In FIG. 2 the cleaning agent chamber 6 with the cleaning agent 10, for example water, contained therein as well as the cleaning agent terminal 8 are each drawn with dashed lines.

FIG. 3 shows the device 1 having an internal cleaning agent chamber 6 as well as the cleaning agent terminal 8 in a sectional side view according to the sectional plane A-A drawn in FIG. 1.

The cleaning device 1 shown herein is made of polyethylene (PE) plastic material. It is also conceivable to produce cleaning devices 1 according to the invention also from other materials, for example from a fibre reinforced plastic material, in particular from glass fibre reinforced polyester resin, from metal or from any other composite material. These embodiments are not explicitly illustrated in the figures.

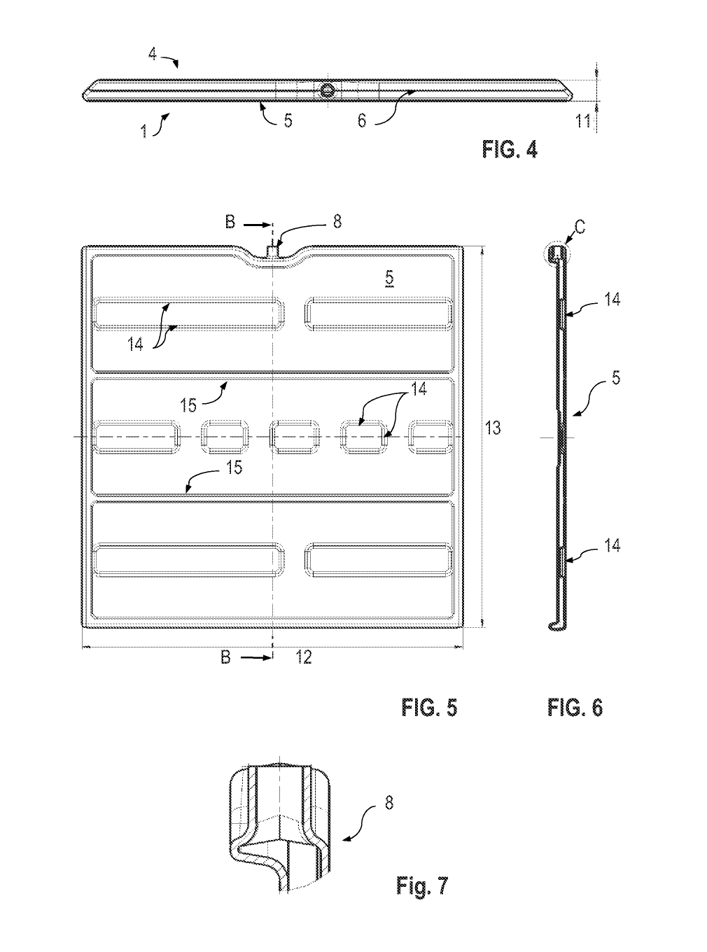

FIG. 4 shows a further embodiment of a cleaning device 1 according to the invention in a very flat configuration in a side view. The cleaning tub 2 herein has a very small tub height 11 of, for example, 30 mm. The cleaning tub 2 is, for example, made of an upper tub part and a lower tub part, which are connected with each other at the narrow sides alongside the lateral edges thereof. The two tub parts are, for example, adhesively bonded with each other in a fluid-tight way. Therein the upper tub part forms the upper tub side 4, whereas the lower tub part forms the lower tub part 5. Within the cleaning tub 2 there is situated a cleaning agent chamber 6, which may be filled by means of a cleaning agent terminal 8 and which has outflow openings 7 towards the upper tub side 4, which are, for example, arranged uniformly within an essentially circular section of the upper tub side 4.

FIG. 5 illustrates in a view from below the lower tub part with the lower tub side 5. The lower tub part has a tub length 12 and a tub width 13. At the lower tub side 5 there are further arranged several reinforcement ridges 14, which are intended for stiffening the lower tub part. In the region of the reinforcement ridges 14 the upper tub part and the lower tub part or the upper tub side 4 and the lower tub side 5, respectively, are connected with each other, for example by crimping. Hence, due to the reinforcement ridges 14 there is guaranteed that also heavy lawn mowers, for example lawn mowers with a seat or lawn mower tractors with a seat, respectively, may be positioned on the cleaning device 1, without this being damaged or deformed. The connection of the upper tub side 4 and the lower tub side 5 is carried out depending on the selection of the material, for example by way of adhesive bonding or welding of the two tub parts.

FIG. 6 shows the cleaning tub 2 according to the sectional plane B-B drawn in FIG. 5 in a sectional side view. In a profile view the crimped reinforcement ridges 14 are clearly visible. There are further provided two drain throughs 16 that are arranged essentially in parallel with each other, which are intended to drain the grass contaminations from the upper tub side 4 during cleaning.

FIG. 7 relates in an expanded sectional view to the detail C of the cleaning agent terminal 8 marked in FIG. 6.

FIG. 8 illustrates another embodiment variant of a device 1 according to the invention in a top view, in which outflow openings 7 are extensively distributed across an area section of the upper tub side 4. Each of these outflow openings 7 has an outflow nozzle 16, by means of which the outflow velocity of the cleaning agent is increased and the cleaning agent consumption is advantageously reduced. In order to prevent any damage, the outflow nozzles 16 are in each case arranged within the outflow openings 7. In this embodiment of the cleaning device 1 a knife chamber at the lower side of a lawn mower is advantageously cleaned especially uniformly and thoroughly.

FIG. 9 shows this embodiment of the cleaning device 1 according to the sectional plane C-C drawn in FIG. 8 in a sectional side view.

### LIST OF POSITION NUMBERS

1 cleaning device
2 cleaning dub
3 restricting border
4 upper tub side
5 lower tub side
6 cleaning agent chamber
7 outflow opening
8 cleaning agent terminal
9 chamfer
10 cleaning agent (water)
11 tub height
12 tub length
13 tub width
14 reinforcement ridge
15 drain through
16 outflow nozzle

1. A device for cleaning a lawn mower, comprising a cleaning tub for positioning the lawn mower, wherein outflow openings for a cleaning agent are arranged at an upper tub side, characterized in that the outflow openings are connected with a cleaning agent chamber integrated in the cleaning tub at a lower tub side.

2. A cleaning device according to claim 1, characterized in that the cleaning agent chamber is connected with a cleaning agent terminal.

3. A cleaning device according to claim 2, characterized in that the cleaning agent terminal laterally protrudes at the cleaning tub.

4. A cleaning device according to claim 1, characterized in that the outflow openings are arranged at the upper tub side essentially in lines, preferably in a circular way.

5. A cleaning device according to claim 1, characterized in that the outflow openings are arranged in concentric circles at the upper tub side.

6. A cleaning device according to claim 1, characterized in that the outflow openings are arranged at least at an area section of the upper tub side.

7. A cleaning device according to claim 1, characterized in that the outflow openings are each provided with an outflow nozzle, preferably with an internally situated outflow nozzle.

8. A cleaning device according to claim 1, characterized in that there is provided at the upper tub side of the cleaning tub at least at a lateral edge, preferably at least at two opposing lateral edges, in each case a restricting border.

9. A cleaning device according to claim 1, characterized in that at least one lateral edge of the cleaning tub is provided with a chamfer.

10. A cleaning device according to claim 1, characterized in that the upper tub side and the lower tub side are section-wise adjoining each other.

11. A cleaning device according to claim 10, characterized in that the upper tub side and the lower tub side are connected with each other in the sections, in which they are adjoining each other.

12. A cleaning device according to claim 1, characterized in that there is provided at the upper tub side at least one drain through.

13. A cleaning device according to claim 1, characterized in that a tub height of the cleaning tub amounts for at most 50 mm, preferably at most 15 mm.

14. A cleaning device according to claim 1, made of one or several of the following materials:
plastics, in particular polyethylene (PE) plastics, fibre-reinforced plastics, in particular glass fibre reinforced polyester resin, metal, composite materials.
